(19) United States
(12) Patent Application Publication
(10) Pub. No.: US 2021/0380326 A1
(43) Pub. Date: Dec. 9, 2021

(54) RINSING AND MIXING LIDS, VESSELS AND CONTAINERS

(71) Applicant: CLEAN CUP CO PTY LTD, Queensland (AU)

(72) Inventors: James Harvey, Queensland (AU); Bradley Edwards, Queensland (AU); Craig Mounsey, Queensland (AU)

(21) Appl. No.: 17/288,407

(22) PCT Filed: Oct. 25, 2019
(86) PCT No.: PCT/AU2019/051179

§ 371 Date: Apr. 23, 2021

(30) Foreign Application Priority Data
Oct. 25, 2018 (AU) 2018904053
Mar. 8, 2019 (AU) 2019900814
Aug. 8, 2019 (AU) 2019902842

(51) Int. Cl. B65D 81/32; B65D 51/28; B65D 51/24; B08B 9/08; F16K 1/36; F16K 31/524

(52) U.S. Cl. CPC B65D 81/3211; B65D 51/2892; B65D 51/248; B08B 2209/08; F16K 1/36; F16K 31/52408; B65D 2217/04; B08B 9/0821

(57) ABSTRACT

A reusable vessel comprises a first compartment to store therein a substance and a second compartment separated from the first compartment by a boundary element comprising a wall or membrane having one or more apertures therein. A valve is movable between a closed position, in which the valve seals the one or more apertures, and an open position allowing the substance to be released from the first compartment into the second compartment, or a substance in the second compartment to mix with the substance in the first compartment. A triggering mechanism is coupled to the valve to move the valve between the open and closed positions. The triggering mechanism comprises one or more external elements coupled to one or more internal cam elements to control the valve, which, when triggered causes the one or more external elements to exhibit a visible change to indicate the open and closed positions of the valve.

### FIELD OF THE INVENTION

The present invention relates to the compartmentalisation of containers or vessels or the like and to containers or vessels comprising multiple compartments. Some embodiments of the present invention relate to reusable lids, caps or covers for reusable containers, and in particular, to lids for reusable drinks containers, such as cups and bottles. In particular, other embodiments of the present invention relate to reusable vessels or containers comprising multiple compartments.

### BACKGROUND TO THE INVENTION

There is a drive to reduce the consumption of resources in many aspects of life in an effort to reduce waste and the impact on the environment, to reduce production costs and to maximise the life span of non-renewable resources. Efforts to achieve this include making production processes more efficient, using renewable sources of energy and materials and making products reusable rather than single use.

Reusable products have been readily adopted in the food and drinks sector. For example, reusable drinks containers, such as coffee cups, baby bottles and protein shakers are commonplace. However, one problem with such reusable containers is that they need to be cleaned after use and before they can be reused and the means to clean such reusable containers is not always readily available, for example when the user is travelling/commuting etc.

Other problems are encountered when two or more substances are to be mixed together in a container. For example, powders are often mixed with water or another liquid to form a solution, often for human consumption, such as baby formula, energy drinks and the like. One problem that exists is how to store one or more of the substances in a reusable container until required for use.

### OBJECT OF THE INVENTION

A preferred object of the present invention is to provide a reusable vessel, container or the like and/or a reusable lid, cap or cover or the like for reusable vessels or containers, in particular, reusable drinks containers, that addresses or at least ameliorates one or more of the aforementioned problems and/or provides a useful commercial alternative.

### SUMMARY OF THE INVENTION

Some aspects of the present invention concern lids, caps or covers or the like for containers or vessels or the like. In particular, some embodiments of the present invention relate to lids for reusable vessels or containers, and in particular reusable lids for reusable drinks containers, such as cups and bottles that enable the container to be rinsed before and/or after use.

Some embodiments of the present invention are directed to reusable containers or vessels comprising compartments, such as, but not limited to integral compartments, for rinsing such containers.

Some embodiments of the present invention relate to reusable vessels or containers comprising multiple compartments, at least one of which stores a substance to be released therefrom, and/or which allows the ingress of another substance to be mixed therewith.

According to one aspect, but not necessarily the broadest aspect, the present invention is directed to a lid attachable to a container or vessel, the lid comprising a compartment to store therein, and release therefrom, a liquid, such as water, to rinse or clean the container or vessel.

According to another aspect, but not necessarily the broadest aspect, the present invention is directed to a lid attachable to a container or vessel, the lid comprising a compartment to store therein, and release therefrom into the container or vessel, a substance.

Suitably, the lid comprises a body portion attachable to the container or vessel and a movable portion coupled to, and movable relative to the body portion.

Suitably, the movable portion is movable between a first position, in which the liquid or substance is retained in the compartment, and a second position in which the liquid or substance is released from the compartment into the container or vessel.

Suitably, the compartment is a void defined by a bottom wall, a first wall, a second wall, and an upper wall of the body portion.

In some embodiments, the bottom wall of the compartment comprises a first off-set aperture and the movable portion comprises a second off-set aperture, wherein alignment, or at least partial alignment of the first and second off-set apertures allows the liquid or substance to be added to and released from the compartment.

Suitably, the bottom wall of the compartment is detachable from, or integrally formed with the body portion.

Suitably, the movable portion comprises an upper portion connected to a lower portion.

Preferably, the upper portion of the movable portion is at least partially received within a recess in an upper surface of the body portion.

Preferably, the lower portion abuts the bottom wall of the compartment.

Suitably, the lower portion comprises a protrusion extending therefrom, the protrusion received within an elongate recess depending from the upper portion, or vice versa, i.e. the protrusion depends from the upper portion which is received within an elongate recess extending from the lower portion.

Suitably, the compartment comprises a channel therethrough defined by the second wall enabling connection of the upper portion and the lower portion of the movable portion.

Suitably, the movable portion comprises a handle, tab, ridge or the like for moving the movable portion by a user's thumb and forefinger.

Suitably, the body portion comprises an outer wall with a perimeter having a recess for coupling and sealing the lid to a rim of an opening or open end of the container or vessel.

Preferably, the body portion comprises a third aperture to allow egress of a product contained in the container or vessel when the lid is attached to the container or vessel.

In some alternative embodiments, the bottom wall of the compartment is slidable or pivotable relative to the body portion to release the liquid from the compartment to rinse or clean the container or vessel, or to release the substance from the compartment into the container or vessel, for example, for mixing with another substance.

In some other alternative embodiments, the lid comprises a resiliently deformable orifice in communication with the compartment, whereupon application of pressure to the lid causes the orifice to open to release the liquid substance from the compartment into the container or vessel.

According to another aspect, but not necessarily the broadest aspect, the present invention is directed to an attachment, such as a lid, a base or a handle, attachable to and detachable from a vessel, the attachment comprising:

a body portion attachable to and detachable from a vessel, the body portion comprising a compartment to store therein, and release therefrom, a substance, wherein a wall of the compartment is attachable to and detachable from the body portion; and

a movable portion coupled to, and movable relative to, the body portion, the movable portion comprising a first portion on a first side of the compartment and a second portion on a second side of the compartment;

wherein the wall of the compartment attachable to and detachable from the body portion and the second portion of the movable portion each comprise a respective aperture which can be aligned, or at least partially aligned by movement of the movable portion to release the substance from the compartment, or to allow the addition of a substance to the compartment.

According to another aspect, but not necessarily the broadest aspect, the present invention is directed to a method of reducing waste comprising providing a lid attachable to a reusable container or vessel, the lid comprising a compartment to store therein, and release therefrom, a liquid, such as water, to rinse or clean the reusable container or vessel.

According to a further aspect, but not necessarily the broadest aspect, the present invention is directed to a method of cleaning a reusable container comprising:

attaching the aforementioned attachment or lid to a vessel, wherein the substance in the compartment is a liquid; and

releasing the liquid from the compartment to rinse or clean the reusable vessel.

According to a yet further aspect, but not necessarily the broadest aspect, the present invention is directed to a method of storing a substance and releasing the substance into a reusable container or vessel, the method comprising:

providing a lid comprising: a body portion attachable to the reusable container or vessel; a compartment to store the substance therein; and a movable portion coupled to, and movable relative to the body portion; and moving the movable portion between a first position, in which the substance is retained in the compartment, and a second position in which the substance is released from the compartment into the container or vessel.

Preferably, the lid is reusable.

According to one aspect, but not necessarily the broadest aspect, the present invention is directed to a container comprising a compartment to store therein, and release therefrom, a liquid, such as water, to rinse or clean the container, wherein at least part of the compartment is integrally formed with the container.

Suitably, the at least part of the compartment is integrally formed at, or towards a bottom of the container. Alternatively, the at least part of the compartment is integrally formed at, or towards a top of the container.

Suitably, the compartment comprises an upper wall, a first, outer wall extending from the upper wall and a second, inner wall extending from the upper wall and spaced apart from the first, outer wall integrally formed with the container.

Suitably, a bottom wall of the compartment is not integrally formed with the container and is attachable to and removeable from a base or bottom of the compartment by an interference, press or friction fit between a recessed side wall of the bottom wall and an inner surface of the first wall of the compartment.

Suitably, a movable portion is coupled to, and movable relative to, the bottom wall of the compartment, the movable portion comprising an upper portion connected to a lower portion.

Suitably, the movable portion is movable between a first position in which off-set apertures in the upper portion are not aligned with off-set apertures in the upper wall such that the liquid is retained in the compartment, and a second position, in which the off-set apertures in the upper portion are aligned, or substantially aligned with the off-set apertures in the upper wall such that the liquid is released from the compartment into the container when the container is inverted.

According to another aspect, but not necessarily the broadest aspect, the present invention is directed to a reusable vessel comprising:

a first compartment to store therein a substance;

a second compartment separated from the first compartment by a boundary element;

wherein the boundary element, or part thereof is movable to allow the substance to be released from the first compartment into the second compartment, or a substance in the second compartment to mix with the substance in the first compartment.

Suitably, the first compartment is provided at, or towards a bottom of the vessel, or at, or towards a top of the vessel, at or towards a side of the vessel, or adjacent another location of the vessel, or in a handle of the vessel.

Suitably, the first compartment, or at least part thereof, is attachable to, and detachable from, the reusable vessel, for example, to and from a lower portion of the vessel, or to and from an upper portion of the vessel, or to and from a side portion of the vessel, or to and from another location of the vessel, or in the form of a handle of the vessel.

Suitably, the first compartment, or at least part thereof, is provided in an adjacent portion or element of the vessel, such as in a base portion of the vessel. Alternatively, the first compartment, or at least part thereof, is provided in a top portion of the vessel, or a lid or a cover for the vessel, or in a handle of the vessel.

Suitably, the first compartment, or at least part thereof, is attachable to, and detachable from, the reusable vessel, for example, via screw threads, or a snap fit or friction fit.

Suitably, the boundary element comprises a wall or membrane having one or more apertures therein and a valve movable between a closed position in which the valve seals the one or more apertures and an open position.

Suitably, the reusable vessel comprises a triggering mechanism in a part of the vessel, such as a button in the base coupled to the valve.

Preferably, at least part of the triggering mechanism exhibits a visible change to indicate a condition or state of the valve, such as, when the valve is in the open position and/or the closed position. Suitably, an external element, such as an indicator, such as the button protrudes from the vessel, such as from the base, thus elevating the base and indicating an open condition of the valve.

Preferably, when the valve is in the closed position, the indicator, such as the button is flush with the base indicating a closed condition of the valve.

Suitably, the triggering mechanism is coupled to the valve by a secondary mechanism which opens and closes the valve, wherein, for example, the button is coupled via a first biasing element to a linear cam traveller, the linear cam traveller is coupled to a radial cam traveller and the radial cam traveller is coupled to a piston of the valve, suitably via a second biasing element.

Suitably, one or more sealing components, such as gaskets or seals are provided at the boundary element between the first compartment and the second compartment.

Suitably, the substance to be released from the first compartment into the second compartment is: a) a liquid, such as water, for rinsing the second compartment; or b) a powder, one or more tablets or capsules, or a gel.

According to a further aspect, but not necessarily the broadest aspect, the present invention is directed to a reusable vessel comprising:

a first compartment to store therein a substance;

a second compartment separated from the first compartment by a boundary element comprising a wall or membrane having one or more apertures therein;

a valve movable between a closed position, in which the valve seals the one or more apertures, and an open position allowing the substance to be released from the first compartment into the second compartment, or a substance in the second compartment to mix with the substance in the first compartment;

and a triggering mechanism coupled to the valve to move the valve between the open and closed positions, the triggering mechanism comprising one or more external elements coupled to one or more internal cam elements to control the valve which, when triggered, causes the one or more external elements to exhibit a visible change to indicate the open and/or closed positions of the valve.

Further features and/or aspects of the present invention will become apparent from the following detailed description.

### BRIEF DESCRIPTION OF THE DRAWINGS

Embodiments of the present invention will now be described by way of example only with reference to the accompanying drawings in which like reference numerals refer to like features. In the drawings:

FIG. 1 is a top perspective view of an attachment in the form of a lid according to an embodiment of the present invention;

FIG. 2 is an underside perspective view of the lid shown in FIG. 1;

FIG. 3 is an exploded top perspective view of the lid shown in FIG. 1;

FIG. 4 is an exploded underside perspective view of the lid shown in FIG. 1;

FIG. 5 is a perspective section view of the lid shown in FIG. 1 attached to a reusable container;

FIG. 6 is an exploded perspective section view of the lid shown in FIG. 1 in relation to a reusable container;

FIG. 7 is a top perspective view of a container comprising an integrally formed compartment according to another embodiment of the present invention;

FIG. 8 is an underside perspective view of the container shown in FIG. 7;

FIG. 9 is a partial sectional perspective view of the container shown in FIG. 7 showing the compartment in a closed position;

FIG. 10 is a partial sectional perspective view of the container shown in FIG. 7 showing the compartment in an open position;

FIG. 11 is a partially exploded perspective view of the container shown in FIG. 7;

FIG. 12 is a fully exploded sectional perspective view of the container shown in FIG. 7;

FIG. 13 is a front view of a container according to another embodiment comprising a compartment in a base portion and comprising a lid;

FIG. 14 is a sectional perspective view of the container shown in FIG. 13;

FIG. 15 is an enlarged view of a lower portion of the sectional perspective view shown in FIG. 13;

FIG. 16 is a perspective view of the base portion of the container shown in FIG. 13;

FIG. 17 is a perspective view of the base portion of the container shown in FIG. 16 with a portion of the base removed and a button in a pressed state;

FIG. 18 is a sectional perspective view of a container according to another embodiment comprising a compartment in a base portion and comprising a lid;

FIG. 19 is a partially exploded view of the container shown in FIG. 18;

FIG. 20 is an exploded view of a lower region of the container shown in FIG. 18;

FIG. 21 is an exploded sectional view of the container shown in FIG. 18;

FIG. 22 is a sectional perspective view of the lower region of the container shown in FIG. 18; and

FIG. 23 is a sectional view of the base portion and a valve of the container shown in FIG. 18.

Skilled addressees will appreciate that elements in the drawings are illustrated for simplicity and clarity and have not necessarily been drawn to scale. For example, the relative dimensions of some of the elements in the drawings may be distorted and/or some elements may be omitted to help improve understanding of embodiments of the present invention.

### DETAILED DESCRIPTION

Some embodiments of the present invention are directed to attachments in the form of lids, caps or covers for containers or vessels or the like. In particular, some embodiments of the present invention relate to lids attachable to reusable containers, and in particular, reusable lids attachable to reusable drinks containers, such as cups and bottles. Some embodiments of the present invention will be described with reference to lids that are particularly suited for attachment to reusable cups typically used for coffee, tea or the like, but it will be appreciated that the present invention is not limited to such applications. For example, embodiments of the present invention can be used with other reusable containers or vessels, such as, but not limited to baby bottles, protein shakers, water bottles, juice bottles or the like and the skilled addressee would recognise any variations required to adapt the lids of the present invention to such applications. Other embodiments of the present invention are directed to reusable containers comprising multiple compartments wherein at least one of the compartments stores a substance for release into the other compartment, for example, for rinsing the other compartment, or for mixing with another substance in the other compartment.

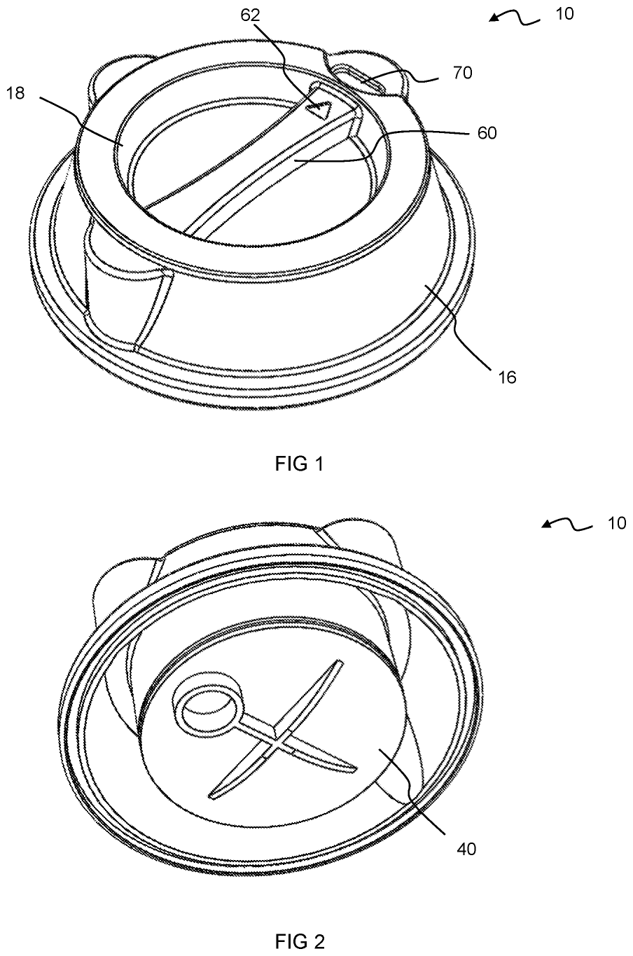

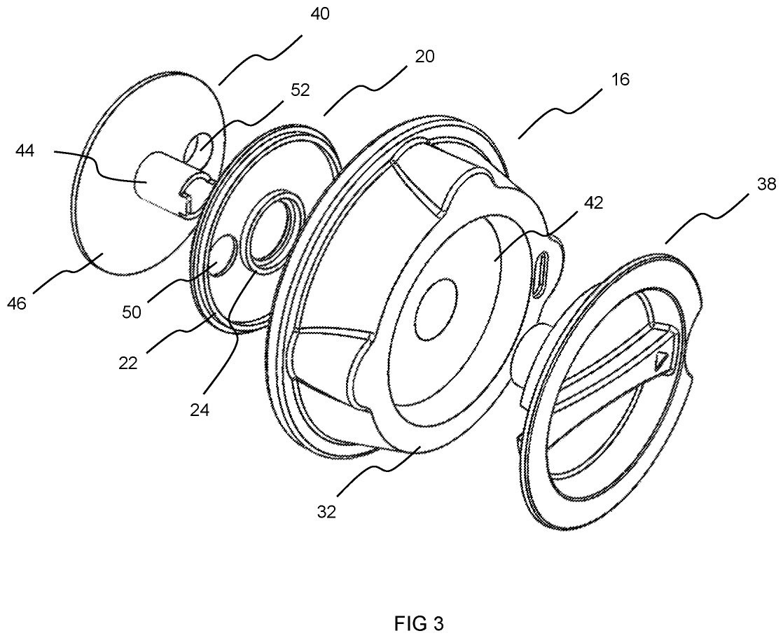

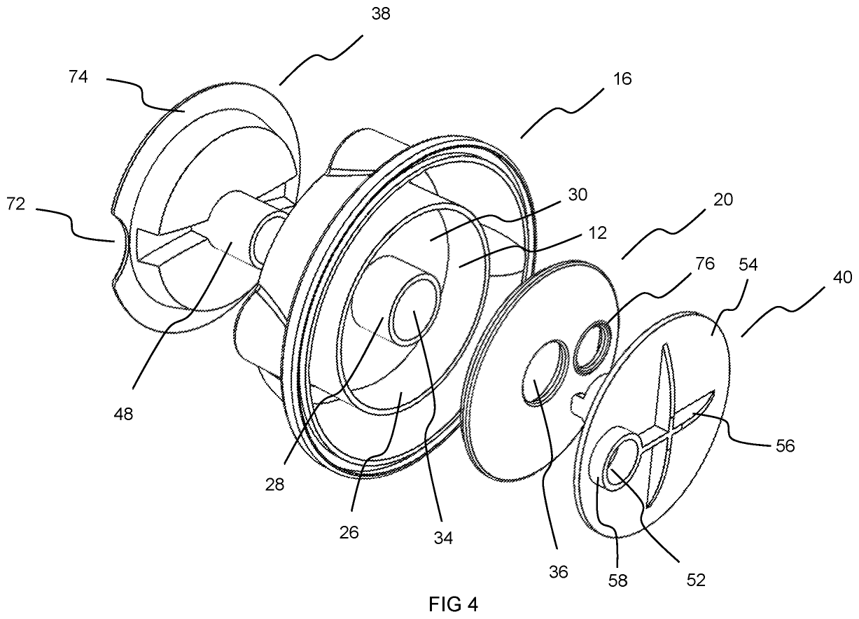

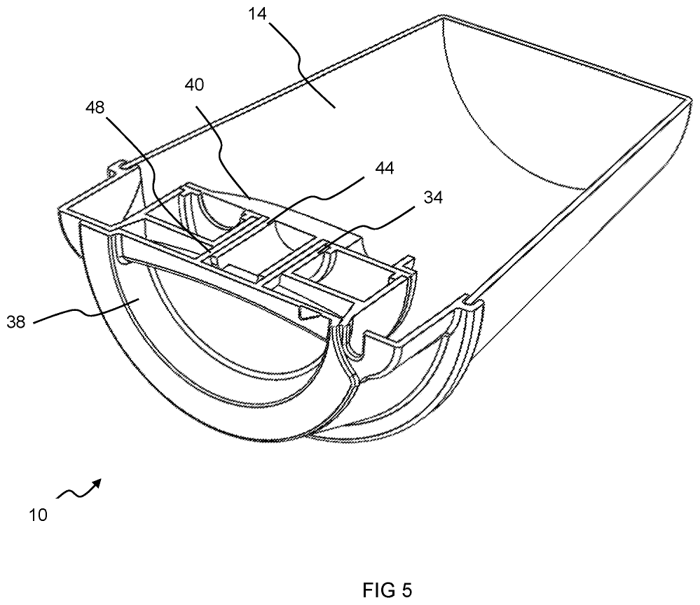

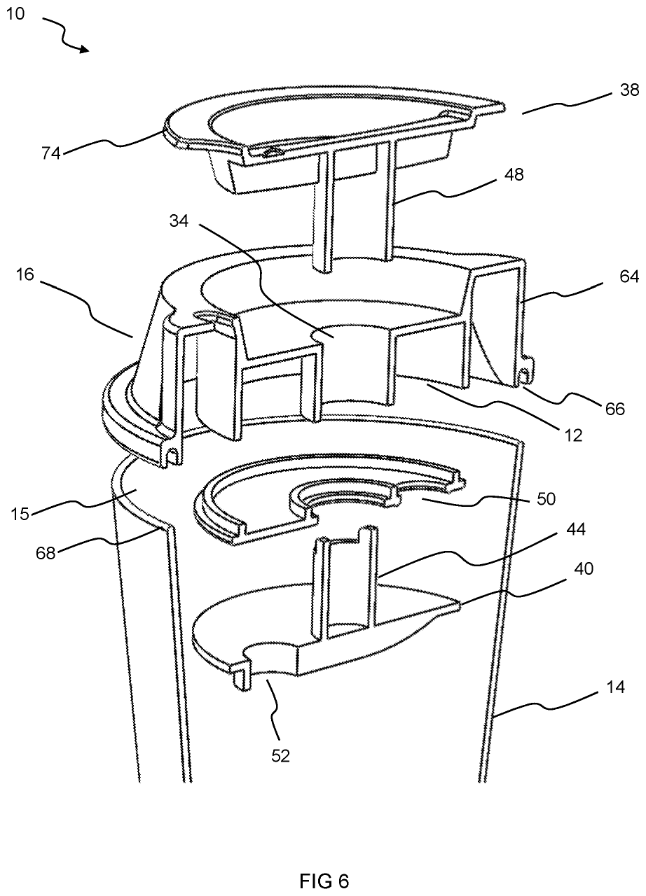

Reference is made to FIGS. 1 and 2, which show a lid 10 according to some embodiments of the present invention, in an assembled state. The lid 10 is attachable to a container or vessel, such as a reusable cup. FIGS. 3 and 4 show an exploded view of the lid 10 and the constituent parts thereof. The lid 10 comprises a compartment 12 to store therein, and release therefrom, a liquid, such as water, to clean the container or vessel, for example, before or after use. FIG. 5 shows a sectional view of the lid 10 attached to the container or vessel 14. FIG. 6 shows a sectional view the constituent parts of the lid 10 in an exploded configuration in relation to the container or vessel 14.

Whilst FIGS. 1-6 show the lid 10 having a generally circular shape to attach to the opening, or open end 15 of the container or vessel 14 having a generally circular shape, it will be appreciated by the skilled addressee that the lid 10 could have a shape other than circular to match and be attachable to a container or vessel 14 having an opening, or open end having a shape other than circular.

With reference to FIGS. 3 and 4 in particular, the lid 10 comprises a body portion 16 attachable to the container or vessel 14 and a movable portion 18 coupled to, and movable relative to the body portion 16. The movable portion 18 is movable between a first position, in which the liquid is retained in the compartment 12, and a second position in which the liquid is released from the compartment 12 into the container or vessel 14. In the second position, the compartment 12 can be refilled with the liquid when the lid 10 is detached from the container/vessel 14.

In this embodiment, the body portion 16 of the lid comprises a substantially planar bottom wall 20 in the form of a disc, which forms a bottom wall of the compartment 12. The bottom wall 20 is attachable to and detachable from the compartment 12 of the body portion 16. The bottom wall 20 comprises a first ridge or flange 22 and a second ridge or flange 24 spaced apart from the first ridge or flange 22 on the same side thereof. The bottom wall 20 attaches to the compartment 12 by an interference, press or friction fit between the first ridge or flange 22 and a first wall 26 of the compartment 12 and an interference, press or friction fit between the second ridge or flange 24 and a second wall 28 of the compartment 12.

Hence, the compartment 12 is a void defined by the bottom wall 20, the first wall 26, the second wall 28 and an upper wall 30 of the body portion 16. The upper wall 30 is the underside of an upper surface 32 of the body portion 16. The second wall 28 defines a channel 34 through the compartment 12. The bottom wall 20 comprises a central aperture 36 coaxial with the channel 34. The void of the compartment 12 is substantially enclosed apart from a first off-set aperture 50 in the bottom wall 20.

In this embodiment, the first and second walls 26, 28 have a circular cross section and are coaxial. In other words, the first and second walls 26, 28 are spaced apart cylinders of different radii, such that the compartment 12 is a 3D annulus. However, it will be appreciated by the skilled addressee that the compartment 12 does not need to be such a shape and other shapes can be used. For example, the first wall 26 does not need to have a circular cross section because the first wall 26 does not need to match the container or vessel 14 having a circular opening, or open end 15.

The movable portion 18 comprises an upper portion 38 connected to a lower portion 40. The upper portion 38 of the movable portion 18 is at least partially received within a recess 42 in the upper surface 32 of the body portion 16. The lower portion 40 is coaxial with and abuts the bottom wall 20 of the compartment 12. Hence, the upper portion 38 and the lower portion 40 are provided on opposite sides of the body portion 16. The lower portion 40 is in the form of a substantially planar disc and comprises a protrusion 44 extending from a first side 46 thereof. The upper portion 38 comprises an elongate recess 48 in the form of an open-ended tube depending therefrom that receives the protrusion 44 of the lower portion 40. With particular reference to FIG. 5, in an assembled state, the elongate recess 48 extends into the channel 34 of the compartment 12 and the protrusion 44 extends into the elongate recess 48. The upper portion 38 and the lower portion 40 of the movable portion 18 are thus connected through the channel 34 and remain attached by an interference, press or friction fit between the protrusion 44 and the elongate recess 48.

In other embodiments, the protrusion 44 depends from the upper portion 38 and the protrusion 44 is received within the elongate recess 48 extending from the lower portion 40.

Whilst the bottom wall 20 of the compartment 12 comprises the first off-centre aperture 50, the lower portion 40 of the movable portion 16 comprises a second off-centre aperture 52. Misalignment of the first and second off-centre apertures 50, 52 represents a first position in which the compartment 12 is sealed and the liquid is retained in the compartment 12. The underside of the bottom wall 20 can comprise an elastomeric seal 76, most clearly visible in FIG. 4, which abuts against the first side 46 of the lower portion 40 which aids in sealing compartment 12. Alignment, or at least partial alignment of the first and second off-centre apertures 50, 52 represents a second position which allows the liquid to be released from the compartment 12 into the container or vessel 14. The second position also allows the liquid to added to the compartment 12 when the lid 10 is detached from the container or vessel 14 and a source of liquid is available.

A second side 54 of the lower portion 46 of the movable portion 16 comprises one or more ribs 56 extending diametrically and a circular wall 58 of the same or a similar height around the second off-centre aperture 52, which contribute to the structural integrity of the lower portion 46.

An outer wall 64 of the body portion 16 of the lid 10 comprises a perimeter having a recess 66 for coupling and sealing the lid 10 to a rim 68 of the open end 15 of the container or vessel 14. It will be appreciated that the recess 66 is of a size and shape to fit the size and shape of the rim 68 to which it is being attached and prevent egress of a product, such as a drink or food product, held in the container or vessel 14.

The upper portion 38 of the movable portion 18 comprises a handle, tab, ridge 60 or the like to facilitate moving of the movable portion 18 by a user's thumb and forefinger. In this embodiment, the ridge 60 extends diametrically.

The body portion 16 can also comprise a third aperture 70 to allow egress of the product contained in the container or vessel 14 when the lid 10 is attached to the container or vessel and the movable portion 18 is in a suitable position. The upper portion 38 of the movable portion 18 comprises a cut-out 72 in a flange 74 of the upper portion 38. The aforementioned suitable position occurs when the cut-out 72 is aligned with the third aperture 70, such that the user can consume the product through the third aperture 70. When the cut-out 72 is not aligned with the third aperture 70, the flange 74 seals the third aperture 70 preventing spillage. The handle, tab, ridge 60 or the like can include an indicium 62, such as an arrow, to identify or highlight the position of the cut-out 72 in the flange 74 and its required alignment with the third aperture 70.

In this embodiment, when the lid 10 is in an assembled state, the indicium 62 is also aligned with the second off-centre aperture 52 in the lower portion 40 of the movable portion 18. Hence, the indicium 62 also identifies the first and second positions of the movable portion 18. When the indicium 62 is aligned with the third aperture 70, i.e. in the first position, or in a consumption position, the first and second off-centre apertures 50, 52 are misaligned such that the compartment 12 is sealed, thus retaining the liquid therein. In this embodiment, rotation of the movable portion 18 through 180 degrees from the first position to the second position aligns the first and second off-centre apertures 50, 52, which releases the liquid from the compartment 12 into the container or vessel 14 to which the lid 10 is attached, to clean the container or vessel. In the second position, the cut-out 72 is no longer aligned with the third aperture 70 because when the container/vessel 14 is being cleaned, the third aperture is not required. Covering of the third aperture 70 by the flange 74 of the upper portion 38 also prevents any egress of the liquid through the third aperture 70 during cleaning.

In some alternative embodiments of the present invention, addition of the liquid to the compartment 12, retention of the liquid therein and release of the liquid from the compartment 12 to clean the reusable container/vessel 14 can be achieved in different ways. For example, in some alternative embodiments, the bottom wall 20 of the compartment 12 is slidable or pivotable relative to the body portion 16. For example, in a slidable configuration, at least a portion of the bottom wall 20 can be accessible through an aperture in the outer wall 64 and slidable along tracks, channels or recesses formed in the body portion 16 to permit movement of the bottom wall 20 between a closed position and an open position to release the liquid from the compartment 12 to clean the container or vessel 14. In this example, at least the lower portion 40 of the movable portion is omitted.

In another example of an alternative embodiment, the lid 10 comprises a resiliently deformable orifice in communication with the compartment 12. In an equilibrium state, the orifice is closed thus sealing the compartment 12 to retain the liquid therein. Upon application of pressure to the lid, such as by squeezing the lid 10 by hand, the orifice is deformed and caused to open to release the liquid from the compartment 12 to clean the container or vessel 14. Releasing the pressure causes the orifice to close. Opening of the orifice by squeezing the lid 10 can also be employed to fill the compartment 12 with liquid. A lid in accordance with such embodiments can be formed from any known resiliently deformable material that is suitable for use with food and drinks and the like and can withstand temperatures typically encountered with food and drinks and the like.

According to another aspect, but not necessarily the broadest aspect, the present invention is directed to a method of reducing waste comprising providing the lid 10 attachable to the reusable container or vessel 14, the lid comprising the compartment 12 to store therein, and release therefrom, a liquid, such as water, to clean the reusable container or vessel 14.

According to a further aspect, but not necessarily the broadest aspect, the present invention is directed to a method of cleaning the reusable container or vessel 14. The method comprises providing the lid 10 attachable to the reusable container or vessel 14, the lid 10 comprising the compartment 12 to store therein, a liquid, such as water. The method comprises releasing the liquid from the compartment 12 to clean the reusable container or vessel 14. It will be appreciated that the method can include the step of filling the compartment 12 with the liquid prior to the releasing step. Releasing the fluid from the compartment 12 can be achieved by any of the means described herein or equivalents that are within the scope of the appended claims.

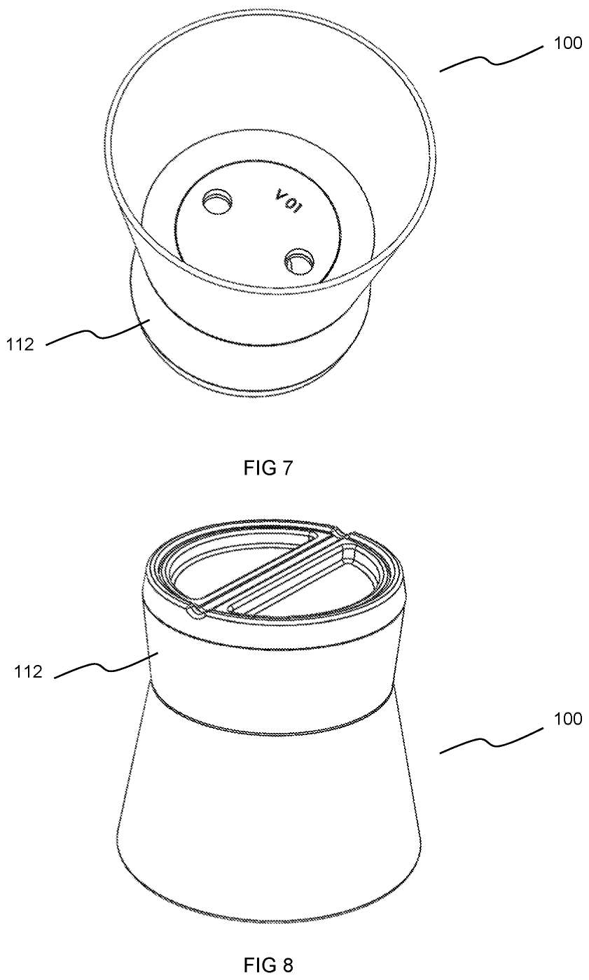

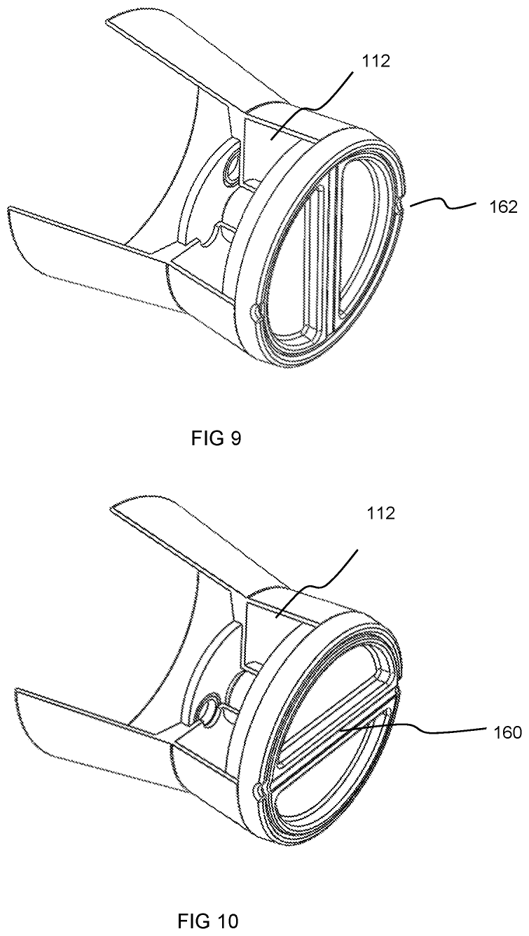

According to yet further embodiments, and with reference to FIGS. 7 to 12, the present invention is in the form of a vessel or container 100, and in particular, a reusable container, comprising a compartment 112 to store therein, and release therefrom, a substance, such as a liquid, such as water, to rinse or clean the container 100. In other embodiments, the substance can be a powder, a gel, or one or more tablets, capsules or the like. At least part of the compartment 112 is integrally formed with the container 100. In the example embodiments, the compartment 112 is integrally formed at a bottom of the container 100. However, in alternative embodiments, the compartment 112 is integrally formed at a top of the container 100. It will be appreciated that the compartment 112, or at least part thereof, can be integrally formed at other positions or locations of the container, such as at one or more sides, depending on the type of container and the purpose of the container. In the example shown in FIGS. 7 to 12, the container is in the form of a cup or drinking vessel, for example, for holding and dispensing a beverage. Although not shown, it will be appreciated that a lid can be releasably attached to the top of the container 100.

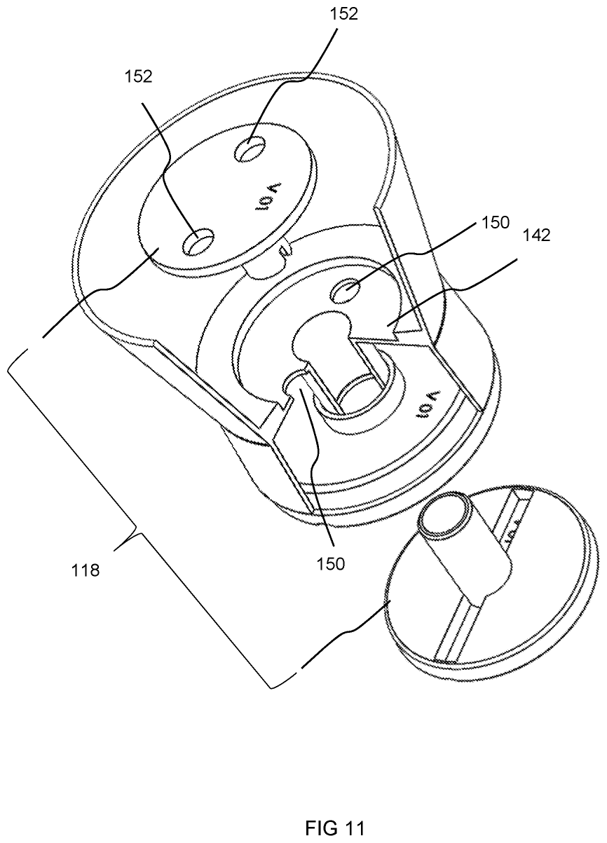

With reference to FIGS. 9 to 12, the compartment 112 comprises an upper wall 130, a first, outer wall 126 extending from the upper wall 130 and a second, inner wall 128 extending from the upper wall 130 and spaced apart from the first, outer wall 126. The upper wall 130, first, outer wall 126 and second, inner wall 128 are integrally formed with the container 100, for example, from a suitable plastics material by known techniques. In this embodiment, the upper wall 130 is substantially circular and the first and second walls 126, 128 have a circular cross section and are coaxial. In other words, the first and second walls 126, 128 are spaced apart cylinders of different radii, such that the compartment 112 is a 3D annulus.

The second wall 128 defines a channel 134 through the compartment 112. The bottom wall 120 comprises a central aperture 136 coaxial with the channel 134. The void of the compartment 112 is substantially enclosed apart from off-set apertures 150 in the upper wall 130. Although two apertures 150 are provided in the upper wall 130, other embodiments can comprise a single aperture 150 or more than two apertures 150.

A bottom wall 120 of the compartment 112 is not integrally formed with the container 100 and is formed separately therefrom. Bottom wall 120 is attachable to and removeable from the base or bottom of the compartment 112 by an interference, press or friction fit between a recessed side wall 180 of the bottom wall 120 and an inner surface of the first wall 126 of the compartment 112.

A movable portion 118 is coupled to, and movable relative to, the bottom wall 120 of the compartment 112. The movable portion 118 comprises an upper portion 138 connected to a lower portion 140.

The upper portion 138 of the movable portion 118 comprises off-set apertures 152. Although two apertures 152 are provided in the upper portion 138, other embodiments can comprise a single aperture 152 or more than two apertures 152. The upper portion 138 is at least partially received within a recess 142 in the upper surface 132 of the upper wall 130. The lower portion 140 is coaxial with and abuts the bottom wall 120 of the compartment 112. In this embodiment, the lower portion 140 is received at least partially within a circular recess 182. Hence, the upper portion 138 and the lower portion 140 are provided on opposite sides of the compartment 112.

The lower portion 140 is in the form of a substantially planar disc and comprises an elongate recess 144 in the form of an open-ended tube extending from a first side 146 thereof. The upper portion 138 comprises a protrusion 148 depending therefrom that is received within the elongate recess 144 of the lower portion 140. In an assembled state, the elongate recess 144 extends into the channel 134 of the compartment 112 and the protrusion 148 extends into the elongate recess 144. The upper portion 138 and the lower portion 140 of the movable portion 118 are thus connected through the channel 134 and remain attached by an interference, press or friction fit between the protrusion 148 and the elongate recess 144. The elongate recess 144 is however movable relative to the channel 134.

The lower portion 140 of the movable portion 118 comprises a handle, tab, ridge 160 or the like to facilitate moving of the movable portion 118 by a user's thumb and forefinger in a clockwise or anti-clockwise direction. In this embodiment, the ridge 160 extends diametrically.

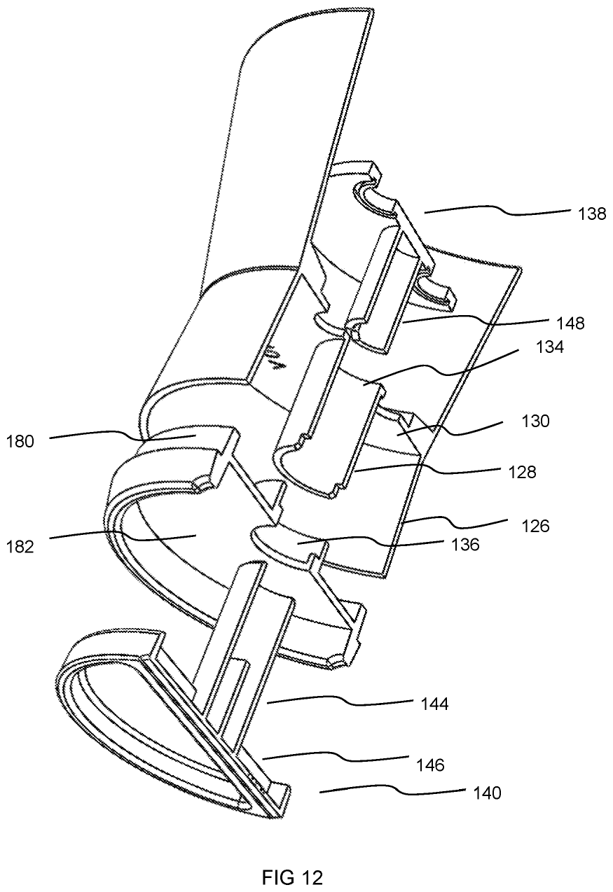

The movable portion 118 is movable between a first position, as shown for example in FIG. 9, in which off-set apertures 152 in the upper portion 138 are not aligned with off-set apertures 150 in the upper wall 130 such that the liquid is retained in the compartment 112, and a second position, as shown for example in FIGS. 7 and 10, in which off-set apertures 152 in the upper portion 138 are aligned with off-set apertures 150 in the upper wall 130 such that the liquid is released from the compartment 112 via the aligned apertures 150, 152 into the container 100 when the container 100 is inverted to rinse the container 100.

In the second position, the compartment 112 can be refilled with the liquid from the top via the aligned apertures 150, 152 and the movable portion 118 moved to the first position to retain the liquid in the compartment. Alternatively, when the movable portion 118 is in the first position or moved thereto, the lower portion 140 and the bottom wall 120 can be removed to add the liquid to the compartment 112 from the bottom before replacing the bottom wall 120 and the lower portion 140.

The bottom wall 120 comprises one or more indents or other indicia 162 with which the handle, tab, ridge 160 or the like of the lower portion 140 of the movable portion 118 are to be aligned to signify to a user that the apertures 150, 152 are aligned such that the liquid will be released from the compartment 112 when the container 100 is inverted.

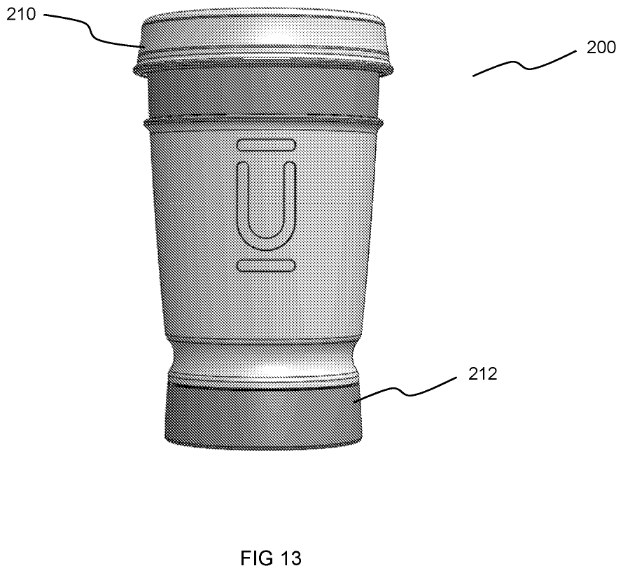

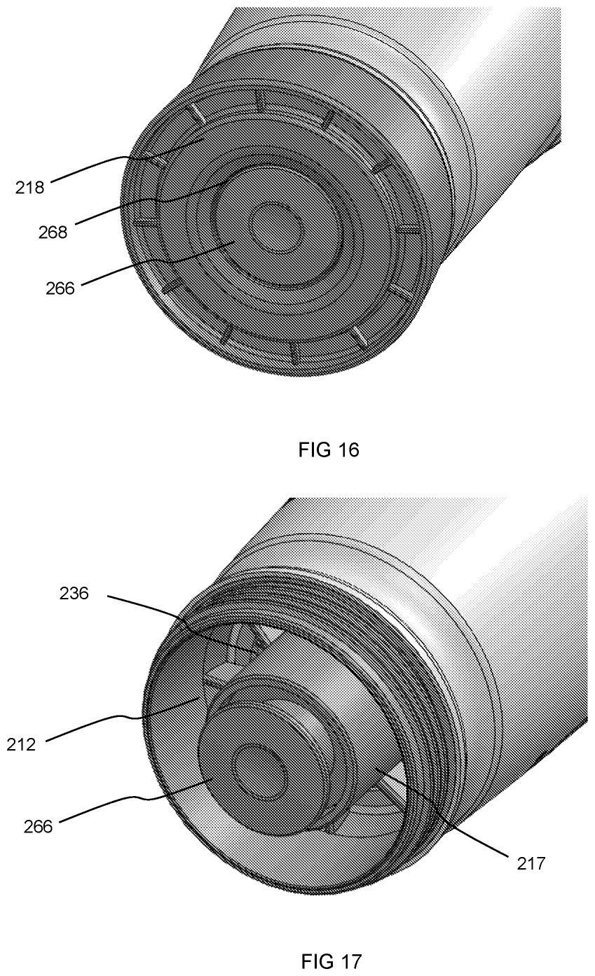

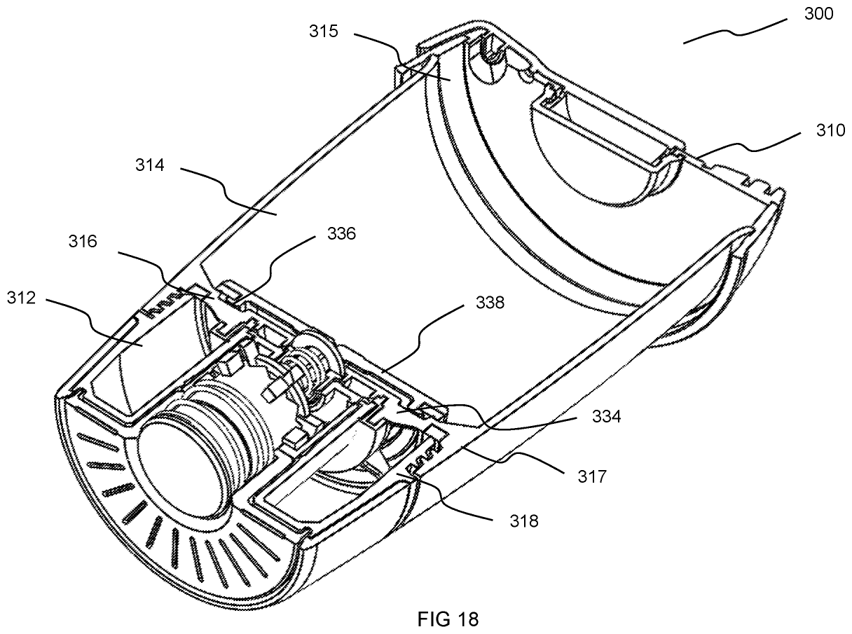

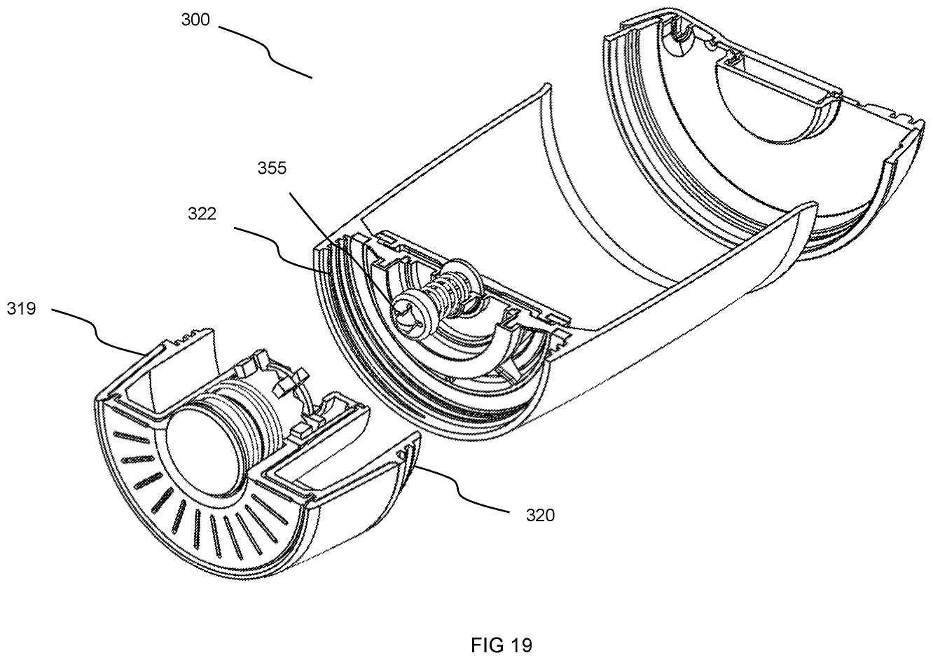

According to some other embodiments, and with reference to FIGS. 13 to 17, the present invention is in the form of a vessel or container 200, and in particular, a reusable vessel or container or the like, comprising a compartment 212 to store therein, and release therefrom, a liquid, such as water. According to some embodiments, the liquid is released from the compartment 212 to rinse or clean the container 200 before or after use. According to some other embodiments, the liquid is released from the compartment 212 to mix with another substance in the container 200 to form a mixture or the like. For example, the liquid stored in the compartment 212 can be water, or purified water, which can be mixed with a soluble substance, such as a powder, to form another substance, such as a high energy drink, milk formula or other solution. According to yet further embodiments, the compartment 212 can store a substance other than a liquid, such as a powder, one or more tablets or capsules, or a gel to be released into the container 200 to be consumed as is, or mixed with one or more other products, such as water.

According to the embodiments shown in FIGS. 13 to 17, the reusable vessel, container or the like 200 comprises a first compartment 212 to store therein a substance, such as a liquid, such as water, or a powder, or a gel, or tablets, or some other substance. The reusable vessel or container 200 comprises a second compartment 214 separated from the first compartment by a boundary element 216. In this embodiment, the second compartment 214 has an opening or open end 215 and a lid 210 is attachable to the opening or open end 215 of the second compartment 214. In the embodiments shown in FIGS. 13 to 17, the reusable vessel or container or the like 200 is in the form of a cup, for example, for drinking liquids through the opening or open end 215 with the lid 210 removed, or through an aperture 211 in the lid 210 when the lid is attached to the vessel or container 200 once a tab 213 has been lifted from the aperture 211 and optionally rotated away. However, it will be appreciated that the uses of the reusable vessel or container 200 are not limited thereto.

In the embodiments shown in FIGS. 13 to 17, the first compartment 212 is provided at, or towards a bottom of the reusable vessel or container 200. However, in other embodiments, the first compartment 212 is provided at, or towards a top of the vessel or container 200, or at, or towards a side of the vessel or container 200, or at, or towards another location of the vessel or container 200, or in a handle or the like of the vessel or container 200.

In the embodiments shown in FIGS. 13 to 17, the first compartment 212, or at least part thereof, is attachable to and detachable from the reusable vessel or container 200. In particular, the first compartment 212, or at least part thereof, is attachable to and detachable from a lower portion 217 of the vessel or container 200. However, in other embodiments, the first compartment 212, or at least part thereof, is attachable to, and detachable from an upper portion of the vessel or container 200, or a side portion of the vessel or container, or another portion of the vessel or container, or is in the form of a handle or the like of the vessel or container. In the embodiments shown in FIGS. 13 to 17, a base 218 of the first compartment 212 is attachable to and detachable from a lower portion of the reusable vessel or container 200 via a screw thread 220 formed on an inner wall of the base 218 and a complimentary screw thread 222 formed on an outer wall of part of the lower portion 217 of the vessel or container 200. However, in other embodiments, the first compartment 212, or at least part thereof, is attachable to, and detachable from, the reusable vessel or container 200, for example, via a snap fit or friction fit.

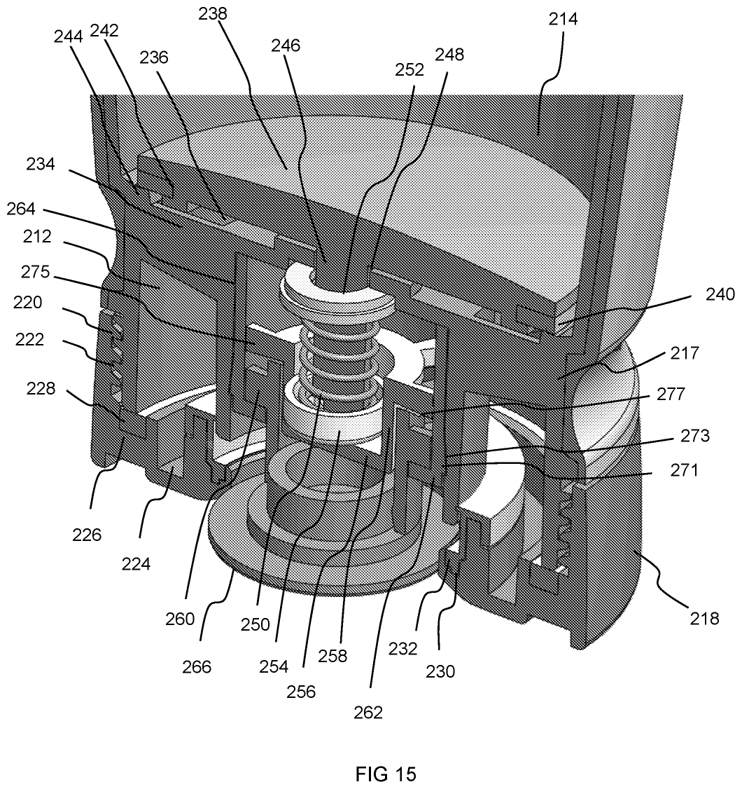

The base 218 comprises one or more annular recesses. In the embodiments shown in FIGS. 13 to 17, and with particular reference to FIG. 15, base 218 comprises a first annular recess 224 that forms part of the first compartment 212 for storing a substance. Base 218 comprises a second annular recess 226 for receiving a first sealing component, such as a first gasket 228 to provide a first seal between the base 218 and the lower portion 217 of the vessel or container 200. Base 218 comprises a third annular recess 230 having a stepped configuration for receiving a second sealing component, such as a gasket 232 to provide a second seal between the base 218 and the lower portion 217 of the vessel or container 200.

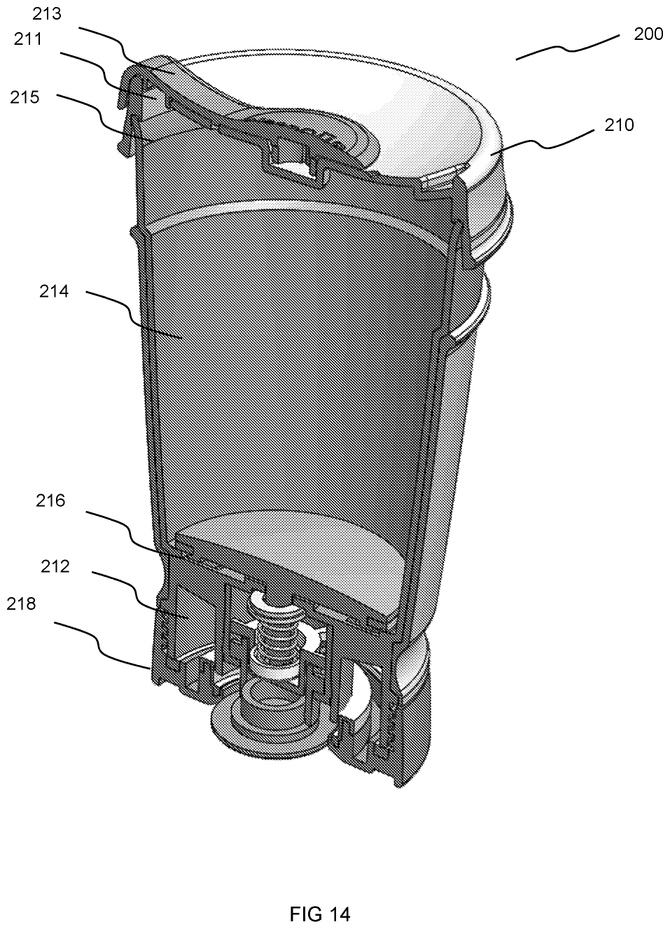

In the embodiments shown in FIGS. 13 to 17, the boundary element 216, or part thereof is movable. In some embodiments, the boundary element 216 comprises a wall 234 forming an upper wall or ceiling of the first compartment 212 and simultaneously forming a lower wall or floor of the second compartment 214. The wall 234 comprises one or more apertures 236 therein and in the embodiments shown an annular aperture 236 is provided in the wall 234. The boundary element 216 comprises a valve 238 having a fourth sealing component, such as a gasket 240 accommodated in a recess 242 thereof which forms a seal between a stepped portion 244 of the wall 234 when the valve 238 is in a closed position, as shown in FIGS. 14 and 15. The valve 238 is movable between the closed position in which the valve 238 seals the one or more apertures 236 and an open position in which the substance is released from the first compartment 212 into the second compartment 214, or a substance in the second compartment 214 mixes with the substance in the first compartment 212.

Where a substance such as water is stored in the first compartment 212, and the first compartment 212 is provided in the lower portion 217 of the reusable container 200 below the second compartment 214, it will be appreciated that when the valve 238 is open, it is necessary to invert the vessel or container 200 to cause the water to flow into the second compartment 214, for example to rinse the second compartment 214, or to mix the substance from the first compartment 212 with the substance in the second compartment 214. The reusable vessel or container 200 comprises a triggering mechanism in a part of the vessel or container 200 coupled to the valve 238. For example, in the embodiments shown in FIGS. 13 to 17, the triggering mechanism is provided in the lower portion 217 of the vessel or container 200 and in the base 218. The valve 238 comprises a piston or rod 246 extending from an underside thereof through a central aperture 248 in the wall 234. A biasing element 250, such as a helical spring, is mounted to the piston or rod 246 between a first piston cap 252 and a second piston cap 254. The second piston cap 254 comprises an aperture to lockingly receive an end of the piston or rod 246.

The second piston cap 254 is seated in a seat 256 of a first internal cam element in the form of a radial cam traveller 258. The radial cam traveller 258 is biased by the biasing element 250 against a second internal cam element in the form of a linear cam traveller 260. The linear cam traveller 260 is seated in a third internal cam element in the form of a cam 262. The cam 262 clips into, or is otherwise held by a cavity 264 in the lower portion 217 of the container 200 for example, by virtue of tabs 271 protruding from a sidewall of the cam 262 received within recesses 273 on an inner wall of the cavity 264. An external element in the form of a button 266 is coupled to the linear cam traveller 260, for example via a friction fit and is accommodated within an aperture 268 in the base 218. Hence, the button 266 is coupled indirectly to the piston 246 of the valve 238 via the internal cam elements 258, 260, 262. Pressing the button 266 causes the valve 238 to open and remain open via interaction of the internal cam elements, in particular, rotation of the radial cam traveller 258 and latching of arms 275 with a sawtooth top profile 277 of the linear cam traveller 260 and compression of the biasing element 250. Pressing the button 266 again causes the valve 238 to close and remain closed until the button 266 is pressed again. Hence, the triggering mechanism comprises one or more external elements, such as button 266, coupled to one or more internal cam elements, such as cam elements 258, 260, 262, to control the valve 238 which, when triggered, causes the one or more external elements, e.g. button 266, to exhibit a visible change to indicate the open and/or closed positions of the valve 238.

In the embodiments shown in FIGS. 13 to 17, the first compartment 212, or at least part thereof, is attachable to, and detachable from, the lower portion 217 of the reusable vessel or container 200. However, in other embodiments, the first compartment 212, or at least part thereof, is attachable to, and detachable from, another portion of the vessel or container, such as an upper portion of the vessel or container, or a side portion of the vessel or container. For example, the first compartment 212, or at least part thereof, can be provided in a top portion of the vessel or container 200, for example, in a lid or a cover for the vessel or container 200. It is also envisaged that in other embodiments, the first compartment 212, or at least part thereof, can be provided in a handle, or other attachment of the vessel or container 200.

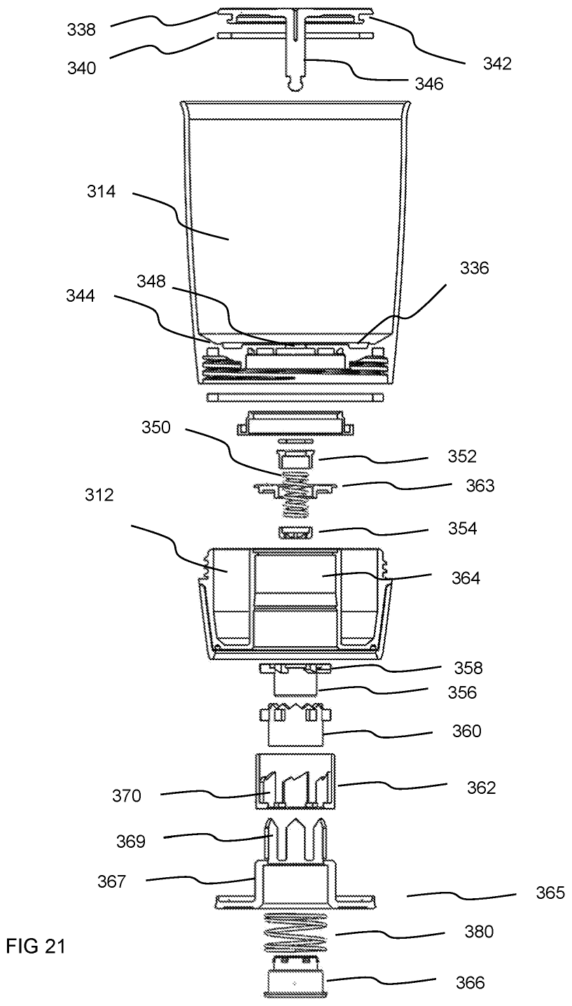

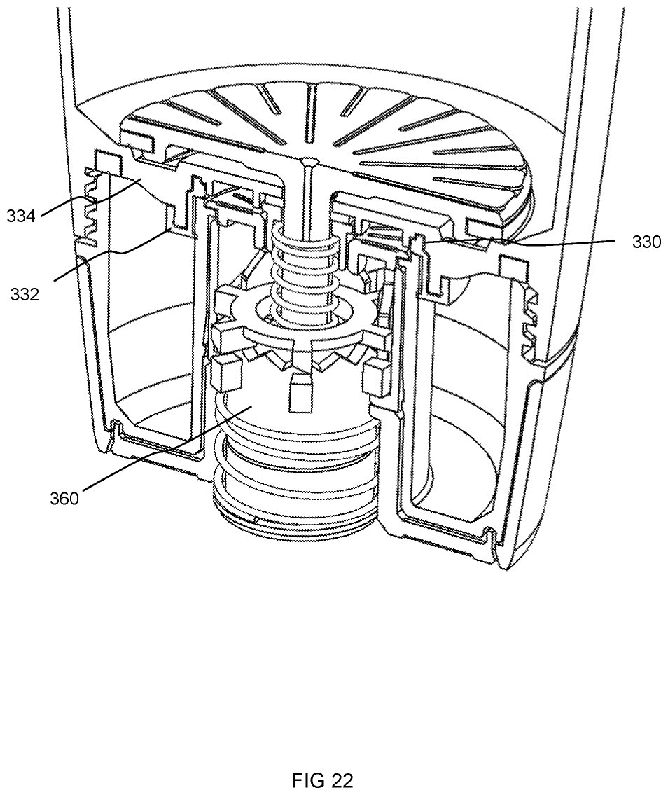

FIGS. 18 to 23 show another embodiment of the present invention in the form of a reusable vessel or container 300, which is similar in some respects to the embodiments of the reusable vessel or container 200 shown in FIGS. 13 to 17. The reusable vessel or container 300 comprises a first compartment 312 to store therein a substance, such as a liquid, such as water, or a powder, or a gel, or tablets, or some other substance, and a second compartment 314 separated from the first compartment 312 by a boundary element 316. In this embodiment, the second compartment 214 has an opening or open end 315 and a lid 310 is attachable to the opening or open end 315. The first compartment 312 is provided at, or towards a bottom of the reusable vessel or container 300, but in other embodiments, the first compartment 312 can be provided at, or towards a top of the vessel or container 300, for example in the lid 310, or at a side of the vessel or container 300, or in a handle or other attachment of the vessel or container 300.

In the embodiments shown in FIGS. 18 to 23, the first compartment 312, or at least part thereof, is attachable to and detachable from the reusable vessel or container 300, for example, to and from a lower portion 317 of the vessel or container 300. However, in other embodiments, the first compartment 312, or at least part thereof, is attachable to, and detachable from an upper portion of the vessel or container 300, or a side portion of the vessel or container, or another portion of the vessel or container 300, or is in the form of a handle or the like of the vessel or container. A base 318 of the first compartment 312 is attachable to and detachable from the lower portion 317 of the reusable vessel or container 200 via a screw thread 320 formed on an outer wall of the base 318 and a complimentary screw thread 322 formed on an inner wall of part of the lower portion 317 of the vessel or container 300. However, in other embodiments, the first compartment 312, or at least part thereof, is attachable to, and detachable from, the reusable vessel or container 300, for example, via a snap fit or friction fit. In this embodiment, an over moulding 319 is attached to the base 318, for example via a snap fit or friction fit. The over moulding 319 abuts and grips a surface upon which the vessel or container 300 is placed.

In the embodiments shown in FIGS. 18 to 23, the boundary element 316, or part thereof is movable. In this embodiment, the boundary element 316 comprises a wall 334 forming an upper wall or ceiling of the first compartment 312 and simultaneously forming a lower wall or floor of the second compartment 314. The wall 334 comprises one or more apertures 336 therein and in the embodiments shown, an annular aperture 336 is provided in the wall 334. The boundary element 316 comprises a valve 338 having a sealing component, such as a gasket 340 accommodated in a recess 342 thereof which forms a seal between a stepped or sloping portion 344 of the wall 334 when the valve 338 is in a closed position. The valve 338 is movable between the closed position in which the valve 338 seals the one or more apertures 336 and an open position in which the substance is released from the first compartment 312 into the second compartment 314, or a substance in the second compartment 314 mixes with the substance in the first compartment 312.

The wall 334 comprises one or more annular recesses therein. In the embodiments shown in FIGS. 18 to 23, wall 334 comprises an annular recess 324 for receiving a sealing component, such as a gasket 328 to provide a seal between the base 318 and the wall 334 above the screw threads 320, 322. Wall 334 comprises an annular recess 330 having a stepped configuration for receiving a sealing component, such as a gasket 332 to provide a second seal between the base 218 and the wall 334.

When a substance such as water is stored in the first compartment 312, and the first compartment 312 is provided in the lower portion 317 of the reusable vessel or container 300 below the second compartment 314, it will be appreciated that when the valve 338 is open, it is necessary to invert the vessel or container 200 to cause the water to flow into the second compartment 314, for example to rinse the second compartment 314, or to mix the substance from the first compartment 312 with the substance in the second compartment 314.

The reusable vessel or container 300 comprises a triggering mechanism in a part of the vessel or container 300 coupled to the valve 338. According to some embodiments, the triggering mechanism comprises one or more external elements coupled to one or more internal cam elements to control the valve which, when triggered, causes the one or more external elements to exhibit a visible change to indicate the open and/or closed positions of the valve 338. For example, in the embodiments shown in FIGS. 18 to 23, the triggering mechanism is provided in the lower portion 317 of the vessel or container 300 and in the base 318.

According to some embodiments, the valve 338 comprises a piston or rod 346 extending from an underside thereof through a central aperture 348 in the wall 334. A biasing element 350, such as a helical spring, is mounted to, or around the piston or rod 346 between a first piston cap 352 and a second piston cap 354. The second piston cap 354 comprises an aperture 355 to lockingly receive an end of the piston or rod 346.

The second piston cap 354 is received in a seat 356 of a first internal cam element in the form of a radial cam traveller 358. The radial cam traveller 358 is biased by the biasing element 350 against a second internal cam element in the form of a linear cam traveller 360. The linear cam traveller 360 is received within, and is seated in a third internal cam element in the form of a cam 362. Cam 362 clips into, or is otherwise held by a cavity 364 in the lower portion 317 of the vessel or container 300, for example, by virtue of tabs 371 protruding from a sidewall of the cam 362 received within recesses 373 on an inner wall of the cavity 364. The top of the cavity 364 is sealed with a cover 363

The triggering mechanism includes a trigger button 365 comprising a recessed protrusion 367 which is received within the cavity 364. A top portion of the recessed protrusion 367 comprises a plurality of fingers 369 or the like extending upwardly therefrom that are received within recesses 370 on an inner wall of the cam 362. The trigger button 365 comprises an annular flange 372 at or near a perimeter thereof which is received within an annular recess 374 in an underside of the base 318.

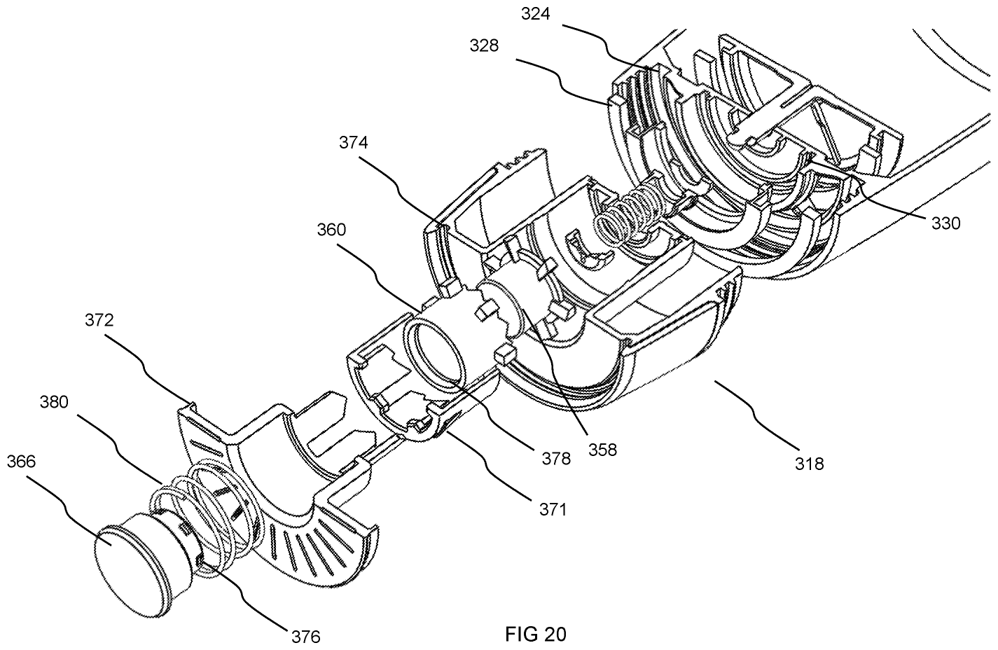

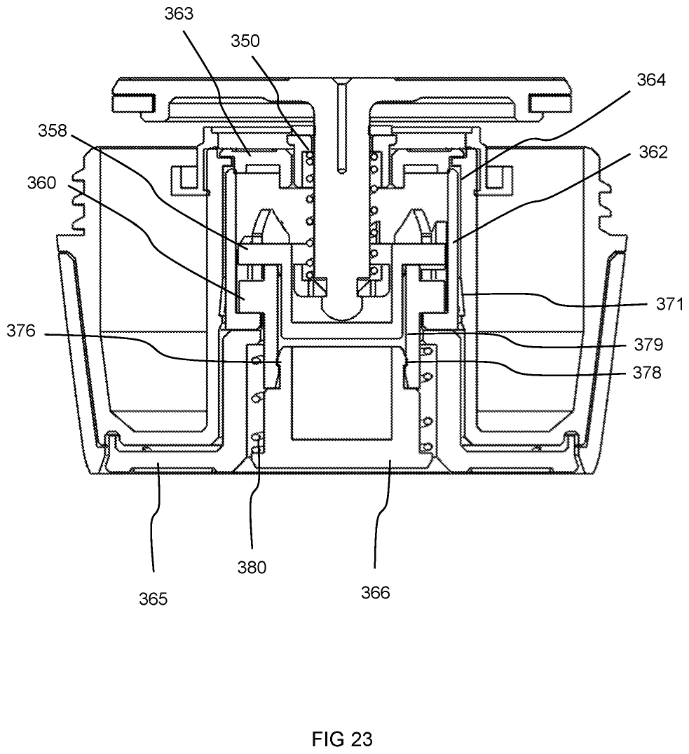

The triggering mechanism includes one or more external elements, such as a button 366 which comprises a plurality of tabs 376 or the like protruding from a side wall thereof. The button 366 is coupled to the linear cam traveller 360, for example, via a friction fit between the tabs 376 and a recess 378 on an inner wall 379 of the linear cam traveller 360, shown most clearly in FIGS. 20 and 23. The button 366 is accommodated within the recessed protrusion 367 in the base 318. A biasing element 380, such as a helical spring is accommodated in the recessed protrusion 367 in the base 318.

Hence, the button 366 is coupled indirectly to the piston 346 of the valve 338. Pressing the button 366 causes the valve 338 to open and remain open through cooperation of the linear cam traveller 360 and the radial cam traveller 358. When the valve 338 is in the open position, the button 366 is caused to protrude from the base 318 thus elevating the base 318 and indicating to a user an open condition of the valve 338.

Pressing the button 366 again causes the valve 338 to close and remain closed through cooperation of the linear cam traveller 360 and the radial cam traveller 358 until the button 366 is pressed again. When the valve 338 is in the closed position, the button 366 is flush with the base 318 indicating a closed condition of the valve 338.

In particular, the triggering mechanism works through two differential biasing elements, such as helical springs 350, 380, in opposing compression. As the trigger button 365 is pressed, the internal mechanism compresses the biasing element 350 and the radial cam traveller 358 rotates and latches under the force generated by this compression. As the radial cam traveller 358 rotates, the tips of the internal arms on button 366 are engaged by the radial cam traveller 358 and the button 366 is forced along the centre axis. In this motion the biasing element 380 is compressed, resulting in button 366 protruding from the base 318. When the trigger button 365 is pushed a second time, the radial cam traveller 358 is freed from the latch, rotates and drops into the reset position. As the radial cam traveller 358 rotates about the centre axis, the internal arms on button 366 are released by the radial cam traveller 358. Hence, the biasing element 380 forces button 366 to reset back into the start position. The internal arms on button 366 also release the radial cam traveller 358 when the protruding button 366 is pressed. In this way the triggering mechanism, and hence the valve 338, can be reset in two ways. Either by pressing the trigger button 365, or by pressing the protruding button 366.

Hence, at least part of the triggering mechanism exhibits a visible change to indicate a condition or state of the valve 338, such as, when the valve is in the open position and/or the closed position. In the embodiments, described herein, an external element or indicator in the form of the button 366 protrudes from the vessel or container 300, such as from the base 318, thus elevating the base 318 above a surface upon which the vessel or container 300 rests indicating an open condition or position of the valve. In some embodiments, at least part of the indicator is coloured to emphasise the open state of the valve 338. For example, a side wall of the button can be brightly coloured to draw a user's attention to the visible change. In other embodiments, the external element or indicator can take on other forms, such as an LED or other form of visual indicator, or an audible indicator, which could be powered by a simple circuit and power source.

It is envisaged that in other embodiments the boundary element 216 comprises a membrane having a state that can be changed between a closed state, in which the membrane is impermeable to the substance(s) in the first compartment 212 and/or the second compartment 214, and an open state, in which the membrane is permeable to the substance(s) in the first compartment 212 and/or the second compartment 214. For example, the membrane may be responsive to a potential difference established by a power source, such as a battery, activated by a user via a button or the like, or responsive to the application of pressure applied by the user, to change the state of the membrane between open and closed states.

Hence, embodiments of the present invention address or at least ameliorate the aforementioned problems. According to some embodiments, the lid 10 comprises a compartment 12 to store therein, and release therefrom, a liquid, such as water, to clean the reusable container or vessel 14. The reusable container or vessel 14 can be promptly cleaned after use even when the means to clean such reusable containers is not always readily available. Prompt cleaning of the reusable container or vessel 14 enables the reusable container or vessel 14 to be reused and prevents, or at least inhibits the development of stains and/or odours and/or mould or the like in the reusable container or vessel 14. The present invention also encourages the use of reusable containers and vessels.

According to other embodiments, the vessel or container comprises a compartment in a lower portion in which water or another liquid can be stored to rinse the container. Such embodiments have improved stability and are safer, particularly if hot water is stored in the compartment. In other embodiments, depending on the application and/or type of vessel or container, the compartment can be located in an upper portion of the vessel or container, in a side portion of the vessel or container, or can be in a handle or other attachment of the vessel or container.

Embodiments in the form of a reusable container or vessel comprising a first compartment and a second compartment separated from the first compartment by a boundary element comprising a movable portion enable a substance to be stored in the first compartment and/or a substance to be stored in the second compartment. The substance is permitted to move into the adjacent compartment, or the substances are permitted to mix as required. Particular embodiments include one or more external elements, such as an indicator in the form of a button, to signify to a user when a valve of the boundary element is open, such that the user can close the valve before introducing a substance into the first compartment and/or the second compartment.

It will be appreciated that at least some of the features of at least some of the embodiments described herein can be combined in various combinations with at least some of the features of at least some of the other embodiments described herein within the scope of the present invention.

In this specification, the terms, “first”, “second” etc. are intended to differentiate between different features of the present invention and are not intended to limit the present invention to a particular order of implementation unless the context indicates otherwise.

In this specification, the terms “comprises”, “comprising” or similar terms are intended to mean a non-exclusive inclusion, such that an apparatus that comprises a list of elements does not include those elements solely but may well include other elements not listed.

The reference to any prior art in this specification is not, and should not be taken as, an acknowledgement or any form of suggestion that the prior art forms part of the common general knowledge.

It will be appreciated that the present invention is not limited to the specific embodiments described herein. Skilled addressees will identify variations from the specific embodiments described herein that will nonetheless fall within the scope of the present invention, which is determined by the following claims.

1. A reusable vessel comprising:
a first compartment to store therein a substance;
a second compartment separated from the first compartment by a boundary element comprising a wall or membrane having one or more apertures therein;
a valve movable between a closed position, in which the valve seals the one or more apertures, and an open position allowing the substance to be released from the first compartment into the second compartment, or a substance in the second compartment to mix with the substance in the first compartment; and
a triggering mechanism coupled to the valve to move the valve between the open and closed positions, the triggering mechanism comprising one or more external elements coupled to one or more internal cam elements to control the valve which, when triggered, causes the one or more external elements to exhibit a visible change to indicate the open and/or closed positions of the valve.

2. The reusable vessel of claim 1, wherein the first compartment is provided at, or towards a bottom of the vessel, or at, or towards a top of the vessel, or at, or near a side of the vessel, or adjacent another location of the vessel, or in a handle of the vessel.

3. The reusable vessel of claim 1 or 2, wherein the first compartment, or at least part thereof, is attachable to, and detachable from, the reusable vessel according to one of the following configurations: to and from a lower portion of the vessel; to and from an upper portion of the vessel; to and from another location of the vessel; in the form of a handle of the vessel.

4. The reusable vessel of claim 1, wherein the first compartment, or at least part thereof, is provided in an adjacent portion or element of the vessel selected from one of the following: a base portion of the vessel; a top portion of the vessel; a lid or a cover for the vessel; an attachment; a handle of the vessel.

5. The reusable vessel of claim 1, wherein the first compartment, or at least part thereof, is attachable to, and detachable from, the reusable vessel via one of the following: screw threads; a snap fit; a press fit; a friction fit.

6. The reusable vessel of claim 1, wherein the triggering mechanism is in a lower portion of the vessel, and the one or more external elements comprises a button in a base of the vessel.

7. (canceled)

8. The reusable vessel of claim 6, wherein at least one of:
the button protrudes from the base thus elevating the base and indicating the open position of the valve, and
when the valve is in the closed position, the button is flush with the base indicating the closed position of the valve.

9. (canceled)

10. The reusable vessel of claim 6, wherein the button is coupled via a first biasing element to a linear cam traveller, the linear cam traveller is coupled to a radial cam traveller and the radial cam traveller is coupled to a piston of the valve.

11. The reusable vessel of claim 10, wherein at least one of:
the piston extends from an underside of the valve through a central aperture in the wall or membrane, and
the piston extends through a first piston cap, a second piston cap and a second biasing element held between the first and second piston caps.

12. (canceled)

13. The reusable vessel of claim 10, wherein the linear cam traveller is received within a cam held in a cavity of the base.

14. The reusable vessel of claim 1, wherein at least one of:
one or more sealing components are provided at the boundary element between the first compartment and the second compartment to provide a seal therebetween, and
the valve comprises one or more sealing components.

15. (canceled)

16. The reusable vessel of claim 1, wherein the substance to be released from the first compartment into the second compartment is selected from one of the following: a liquid for rinsing the second compartment; a powder; one or more tablets; one or more capsules; a gel.

17. An attachment attachable to and detachable from a vessel, the attachment comprising:
a body portion attachable to and detachable from a vessel, the body portion comprising a compartment to store therein, and release therefrom, a substance, wherein a wall of the compartment is attachable to and detachable from the body portion; and
a movable portion coupled to, and movable relative to, the body portion, the movable portion comprising a first portion on a first side of the compartment and a second portion on a second side of the compartment;
wherein the wall of the compartment attachable to and detachable from the body portion and the second portion of the movable portion each comprise a respective aperture which can be aligned, or at least partially aligned by movement of the movable portion to release the substance from the compartment, or to allow the addition of a substance to the compartment.

18. The attachment of claim 17, wherein the movable portion is movable between a first position, in which the substance is retained in the compartment, and a second position in which the substance is released from the compartment into the container or vessel.

19. The attachment of claim 17, wherein the compartment is a void defined by a bottom wall, a first wall, a second wall, and an upper wall of the body portion.

20. The attachment of claim 19, wherein at least one of:
the bottom wall is the wall of the compartment that is attachable to and detachable from the body portion, and
the bottom wall of the compartment is slidable relative to the body portion or pivotable relative to the body portion to release the substance from the compartment.

21. (canceled)

22. The attachment of claim 17, wherein the first portion is connected to the second portion via a protrusion extending from the second portion received within an elongate recess depending from the first portion, or vice versa.

23. The attachment of claim 22, wherein the protrusion and the elongate recess extend into a channel through the compartment.

24. The attachment of claim 17, wherein the movable portion comprises a handle, tab, ridge or the like to move the movable portion by a user's thumb and forefinger.

25. The attachment of claim 17, wherein at least one of:
the body portion comprises an outer wall with a perimeter having a recess to couple and seal the attachment to a rim of an opening or open end of the vessel, and
the body portion comprises a third aperture to allow egress of a product contained in the vessel when the attachment is attached to the vessel.

26. (canceled)

27. The attachment of claim 17, wherein the attachment is one of the following: a lid attachable to and detachable from a top of a cup; a base attachable to and detachable from a bottom of a cup; a handle attachable to and detachable from a side of a cup.

28. The attachment of claim 17, wherein the substance is water which is releasable from the compartment to rinse or clean the vessel.

29. The attachment of claim 17, wherein at least part of the compartment is integrally formed with the vessel.

30. The attachment of claim 17, wherein the at least part of the compartment is integrally formed at, or towards a bottom of the vessel, or at, or towards a top of the vessel.

31. A method of rinsing or cleaning a reusable vessel comprising:
attaching the attachment of claim 17 to a vessel, wherein the substance in the compartment is a liquid; and
releasing the liquid from the compartment to rinse or clean the reusable vessel.
